(19) United States
(12) Patent Application Publication
(10) Pub. No.: US 2010/0080405 A1
(43) Pub. Date: Apr. 1, 2010

(54) SILICON CONDENSER MICROPHONE PACKAGE

(75) Inventors: ZHI-JIANG WU, Shenzhen (CN); MING LIU, Shenzhen (CN); KAI WANG, Shenzhen (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/567,713

(22) Filed: Sep. 25, 2009

(30) Foreign Application Priority Data
Sep. 26, 2008 (CN) 200820212178.2

(51) Int. Cl. H04R 11/04

(52) U.S. Cl. 381/174

(57) ABSTRACT

A silicon condenser microphone package includes a printed circuit board, a cover mounted on the printed circuit board, and a transducer unit and a controlling circuit both attached to the printed circuit board. An inner board is located in the cover. The sensitivity and frequency response of the silicon condenser microphone package is desirable.

### BACKGROUND OF THE INVENTION

1. Field of the Invention

The present invention generally relates to the art of microphone packages and, more particularly, to a silicon condenser microphone package.

2. Related Art of the Invention

Mobile communication technology has progressed rapidly in recent years. Consumers are increasingly using mobile communication devices such as cellular phones, web-enabled cellular telephones, Personal Digital Assistants (PDAs), hand-held computers, laptops, tablets and other devices capable of communication over public or private communication networks. The expansion of cellular networks and technological advancements in mobile communications has resulted in more consumer using mobile communications devices. This increased demand for communication devices drives improvements in the manufacturing processes, power consumption, reception, fabrication, and miniaturization of audio components incorporated in the mobile communication devices. Competitive pressures among suppliers of mobile communication devices increase the demand for smaller, less expensive, and better performing miniature condenser microphones.

U.S. Pat. No. 7,166,910 B2 discloses a condenser microphone including a printed circuit board (PCB), a microphone die mounted on the PCB, and a cover covering the microphone die. The PCB defines a back volume which is covered by the microphone die for providing a pressure reference for the microphone die. However, the cubage of the back volume is too limited to satisfy the demand of frequency response.

So, it is necessary to provide a new means for solving the problem mentioned above.

### SUMMARY OF THE INVENTION

In a preferred embodiment of the present invention, an silicon condenser microphone package comprises a printed circuit board defining a first aperture, a second aperture, and a connecting channel communicating the first aperture with the second aperture. A plurality of first walls is provided to form an entrance chamber communicating with the first aperture, one of the first walls being provided with an acoustic port for receiving external acoustic waves into the entrance chamber. A plurality of second walls is provided to form a back chamber for receiving a transducer unit with an acoustic chamber, the acoustic chamber being communicated with the back chamber.

Other features and advantages of the present invention will become more apparent to those skilled in the art upon examination of the following drawings and detailed description of embodiments.

### BRIEF DESCRIPTION OF THE DRAWINGS

FIG. 1 is a cross-sectional view of a silicon condenser microphone package in accordance with a first embodiment of the present invention; and

FIG. 2 is a cross-sectional view of a silicon condenser microphone package in accordance with a second embodiment of the present invention.

### DETAILED DESCRIPTION OF THE EMBODIMENT OF THE INVENTION

Reference will now be made to describe embodiments of the present invention in detail.

Silicon condenser microphone packages are widely used in consumer products, such as mobile phones and computers, to convert the acoustic waves into electronic signals.

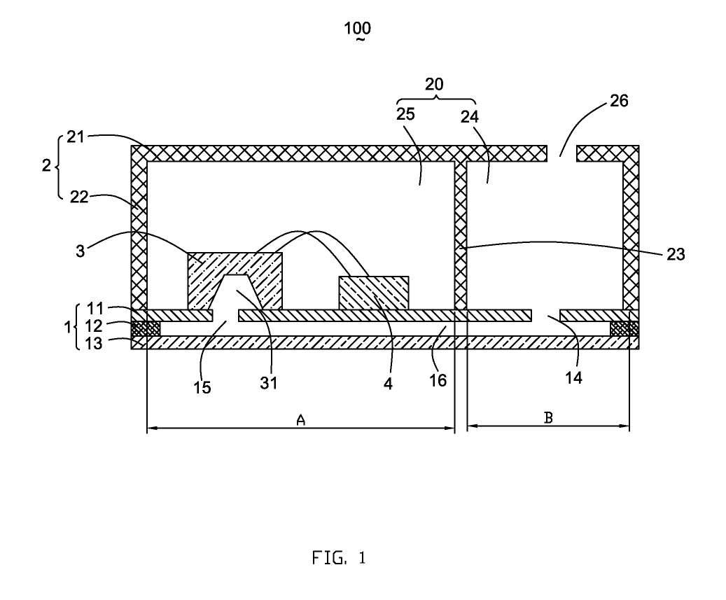

A first embodiment of a silicon condenser microphone package according to the present invention is shown in FIG. 1. The silicon condenser microphone package 100 comprises a printed circuit board 1 and a cover 2 mounted on the printed circuit board 1. The cover 2 forms a receiving chamber 20 for accommodating a transducer unit 3 and a controlling circuit 4, which are both mounted on the printed circuit board 1.

The cover 2 defines an upper wall 21 and a plurality of side walls 22 extending from the upper wall 21 for forming the receiving chamber 20. The cover 2 further defines an inner board 23 extending from the upper wall 21 to an upper surface of the printed circuit board 1. The inner board 23 divides the receiving chamber 20 into a back chamber 25 and an entrance chamber 24. In addition, the upper wall 21 defines an acoustic port 26, which may be covered by a mask layer to prevent water, particles and/or light from entering the package, for receiving external acoustic waves into the receiving chamber 20.

The printed circuit board 1 defines a first aperture 14 communicating with the entrance chamber 24, a second aperture 15 communicating with the back chamber 25 and a connecting channel 16 inside the printed circuit board 1 for communicating the first aperture 14 with the second aperture 15. The printed circuit board 1 comprises a first layer 11, a second layer 13, and a third layer 12 sandwiched between the first and second layers 11, 13. The first aperture 14 and the second aperture 15 are drilled completely through the first layer 11 and the connecting channel 16 is formed on the third layer 12.

The transducer unit 3 has an acoustic chamber 31 directly communicating with either the second aperture 15 of the printed circuit board 1 or the back chamber 25.

The position of the inner board 23 in the receiving chamber 20 can be changed for varying a volume of the back chamber 25. The upper wall 21 is either integrated with the side walls 22 or separated from the side walls 22. The proper proportion between a length A of the back chamber 25 along a transverse direction and a length B of the entrance chamber 24 along the transverse direction is 4:1 for improving the sensitivity and frequency response of the silicon condenser microphone package 100.

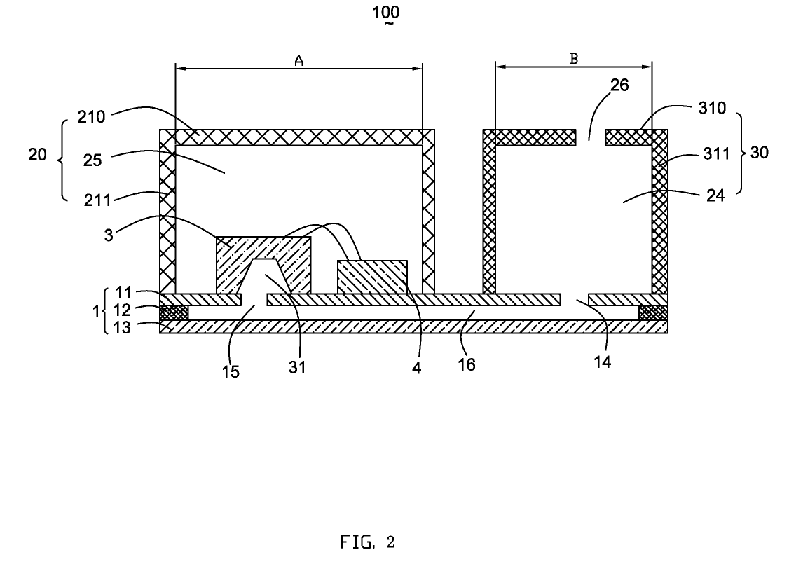

Referring to FIG. 2, a silicon condenser microphone package 100 in accordance with a second embodiment of the present invention is illustrated. The microphone package 100 comprises a printed circuit board 1, a first cover 20, a second cover 30 separated from the first cover 20, a transducer unit 3 and a controlling circuit 4 both attached to the printed circuit board 1 and received in the first cover 20. The first and second covers 20, 30 are both mounted on the printed circuit board 1.

The first cover 20 defines a third wall 210, a plurality of forth walls 211 extending from the third wall 210, and a back chamber 25 formed corporately by the third wall 210 and the forth walls 211 for receiving the transducer unit 3 and controlling circuit 4. The second cover 30 defines a first wall 310 with an acoustic port 26, a plurality of second walls 311 extending from the first wall 310, and an entrance chamber 24 formed corporately by the first wall 310 and the second walls 311.

The printed circuit board 1 defines a first aperture 14 communicating with the entrance chamber 24, a second aperture 15 communicating with the back chamber 25 and a connecting channel 16 inside the printed circuit board 1 for communicating the first aperture 14 with the second aperture 15. The proper proportion between a length A of the back chamber 25 along a transverse direction and a length B of the entrance chamber 24 along the transverse direction is 4:1 for improving the sensitivity and frequency response of the silicon condenser microphone package 100.

In brief, when the microphone package works, the acoustic waves enter the entrance chamber via the acoustic port and then enter the connecting channel via the first aperture and finally enter the transducer unit via the second aperture. Meanwhile, the cubage of the back chamber as a back volume of the transducer unit is enlarged. Therefore, the sensitivity and frequency response of silicon condenser microphone package is desirable.

While the present invention has been described with reference to a specific embodiment, the description of the invention is illustrative and is not to be construed as limiting the invention. Several of modifications to the present invention can be made to the preferred embodiment by those skilled in the art without departing from the true spirit and scope of the invention as defined by the appended claims.

What is claimed is:

1. A silicon condenser microphone package comprising:
a printed circuit board defining a first aperture, a second aperture and a connecting channel communicating the first aperture with the second aperture;
a cover mounted on the printed circuit board and defining an acoustic port in an upper wall thereof and a receiving chamber therein;
an inner board received in the receiving chamber for dividing the receiving chamber into a back chamber communicating with the second aperture and an entrance chamber communicating with the first aperture for allowing acoustic waves to enter the first aperture via the acoustic port;
a transducer unit with an acoustic chamber attached to the printed circuit board and received in the back chamber; and
a controlling circuit mounted on the printed circuit board and received in the back chamber.

2. The silicon condenser microphone package as described in claim 1, wherein the proper proportion between a length of the back chamber along a transverse direction and a length of the entrance chamber along a transverse direction is 4:1.

3. The silicon condenser microphone package as described in claim 2, wherein 7 the cover further defines a plurality of side walls integrated with and extending from the upper wall.

4. The silicon condenser microphone package as described in claim 2, wherein the cover further defines a plurality of side walls extending from the upper wall, and the upper wall is separable from the side walls.

5. The silicon condenser microphone package as described in claim 4, wherein the printed circuit board comprises a first layer, a second layer, and a third layer sandwiched between the first layer and the second layer for forming the connecting channel.

6. The silicon condenser microphone package as described in claim 5, wherein the inner board extends from an upper wall of the cover to an upper surface of the printed circuit board.

7. The silicon condenser microphone package as described in claim 6, wherein the acoustic chamber of the transducer unit communicated with the second aperture, directly.

8. The silicon condenser microphone package as described in claim 7, wherein the acoustic chamber of the transducer unit communicated with the back chamber, directly.

9. A silicon condenser microphone package comprising:
a printed circuit board defining a first aperture, a second aperture and a connecting channel communicating the first aperture with the second aperture;
a first cover mounted on the printed circuit board;
a second cover separated from the first cover and defining an acoustic port in an upper wall thereof and communicating with the first aperture for allowing acoustic waves to enter the first aperture via the acoustic port;
a transducer unit with an acoustic chamber attached to the printed circuit board and received in the first cover; and
a controlling circuit mounted on the printed circuit board and received in the first cover.

10. The silicon condenser microphone package as described in claim 9, wherein the proper proportion between a length of the back chamber along a transverse direction and a length of the entrance chamber along a transverse direction is 4:1.

11. The silicon condenser microphone package as described in claim 9, wherein the second cover defines a first wall, a plurality of second walls extending from the first wall, and an entrance chamber formed corporately by the first wall and the second walls for communicating with the first aperture for allowing acoustic waves to enter the first aperture via the acoustic port.

12. The silicon condenser microphone package as described in claim 10, wherein the first cover defines a third wall, a plurality of forth walls extending from the third wall, and a back chamber formed corporately by the third wall and the forth walls for receiving the transducer unit and controlling circuit.

13. A condenser microphone package, comprising:
a printed circuit board defining a first aperture, a second aperture, and a connecting channel communicating the first aperture with the second aperture;
a plurality of first walls forming an entrance chamber communicating with the first aperture, one of the first walls being provided with an acoustic port for receiving external acoustic waves into the entrance chamber; and
a plurality of second walls forming a back chamber for receiving a transducer unit with an acoustic chamber, the acoustic chamber being communicated with the back chamber.

14. The silicon condenser microphone package as described in claim 13, wherein the proper proportion between a length of the back chamber along a transverse direction and a length of the entrance chamber along a transverse direction is 4:1.
